(19) United States
(12) Patent Application Publication
(10) Pub. No.: US 2011/0162497 A1
(43) Pub. Date: Jul. 7, 2011

(54) LEG-SURROUNDING OPENING FORMING APPARATUS AND METHOD OF MANUFACTURING ABSORBENT ARTICLE

(75) Inventor: Hiroki Yamamoto, Kagawa (JP)

(73) Assignee: UNICHARM CORPORATION, Ehime (JP)

(21) Appl. No.: 12/744,000

(22) PCT Filed: Mar. 2, 2010
(86) PCT No.: PCT/JP2010/053738

§ 371 Date: Mar. 3, 2011

(30) Foreign Application Priority Data
Mar. 2, 2009 (JP) 2009-048416
Feb. 26, 2010 (JP) 2010-041926

(51) Int. Cl. B26D 1/36; B26D 3/10

(52) U.S. Cl. 83/55; 83/346

(57) ABSTRACT

A leg-surrounding opening forming apparatus (100) according to the present invention includes: a cutter roller (110) having an outer circumferential surface provided with blades (112) to cut predetermined regions (44) corresponding to L-size openings (40L) in a web (7), and configured to rotate at a fixed speed when a leg-surrounding openings (40) of a single size are formed; an anvil roller (120) facing the cutter roller (110) across the web (7); and a controller unit (130) configured to control a cutter circumferential speed (c). The controller unit (130) is configured to control the cutter circumferential speed (c) in such a manner as to equalize the cutter circumferential speed (c) to a conveyance speed (v) of the web (7) when the L-size openings (40L) are formed, and to make the cutter circumferential speed (c) higher than the conveyance speed (v) of the web (7) when M-size openings (40M) are formed.

### TECHNICAL FIELD

The present disclosure relates to a leg-surrounding opening forming apparatus and a method of manufacturing an absorbent article with which leg-surrounding openings of different sizes can be formed in a continuous web to make absorbent articles of various sizes.

### BACKGROUND ART

An absorbent article such as a pants-type disposable diaper includes a front waistline portion to be fitted to the front waist of a wearer, a back waistline portion to be fitted to the back waist of the wearer, and a crotch portion to be fitted to the crotch of the wearer.

Leg-surrounding openings into which the legs of the wearer are inserted are formed at both sides of the crotch portion.

A method of manufacturing such an absorbent article includes the step of forming, at a leg-surrounding opening forming apparatus, the leg-surrounding openings in a web being continuously conveyed with absorbers as components of absorbent articles held therein.

Specifically, the leg-surrounding opening forming apparatus includes a cutter roller and an anvil roller.

The outer periphery of the cutter roller is provided with blades to cut predetermined regions of the web corresponding to the leg-surrounding openings. The anvil roller faces the cutter roller across the web.

The leg-surrounding openings are formed in the web being conveyed by pressing the predetermined regions of the web between the blades and the anvil roller.

Generally, in the leg-surrounding opening forming apparatus, the conveyance speed of the web, the circumferential speed of the cutter roller, and the circumferential speed of the anvil roller are all equal.

Accordingly, uniform leg-surrounding openings can be formed, and thereby absorbent articles with high quality can be manufactured.

Absorbent articles are manufactured in different sizes, such as S size, M size and L size.

The size of the leg-surrounding opening in the conveyance direction of the web varies depending on the size of the absorbent article to be made.

However, the size of the leg-surrounding opening cannot be changed if the cutter roller rotates at a fixed speed.

In this case, a unit such as the cutter roller needs to be exchanged to change the size of the leg-surrounding opening to be cut.

For this purpose, there is proposed a leg-surrounding opening forming apparatus in which the circumferential speed of the cutter roller is changed when the blades are in contact with the web (namely, are cutting the web) during one rotation of the cutter roller (see PTL 1, for example).

In order to form openings in a plurality of sizes by a cutter in one size provided in a cutter roller, the cutter roller and a conveyance speed of a web need to be different. In other words, during one rotation of the cutter roller, a peripheral speed of the cutter roller relative to the conveyance speed of the web needs to be changed. With this respect, the inventors have discovered that the above-described leg-surrounding forming apparatus has the following problems.

Since so much load is imposed on a drive mechanism such as a gear and a motor to rotate the cutter roller because of weight and rotating speed of the cutter roller, lifetime of the leg-surrounding forming apparatus becomes short.

In addition, a crease (twist) is likely to occur in the web when the blades are in contact with the web. Thus, the leg-surrounding openings in stable shapes are not easily formed. Therefore, manufacturing defects may occur in some absorbent articles.

In view of the foregoing circumstances, an object of the present invention is to provide a leg-surrounding opening forming apparatus and a method of manufacturing an absorbent article that are capable of reducing apparatus breakdown and more surely preventing manufacturing defects of absorbent articles when manufacturing leg-surrounding openings of different sizes.

### CITATION LIST

### Patent Literature

PTL 1: Japanese Patent Application Publication No. 2003-145485 (pp. 2 to 4, FIGS. 1 and 2)

### SUMMARY

To solve the above-described problem, the present invention has the following aspects.

A first aspect of the present invention is summarized as a leg-surrounding forming apparatus configured to form first leg-surrounding opening regions for a first size of an absorbent article and second leg-surrounding opening regions for a second size of the absorbent article in a continuous web to be processed into absorbent articles each having at least leg-surrounding opening regions formed therein, the apparatus including: a cutter roller having an outer circumferential surface provided with blades to cut predetermined regions corresponding to the first leg-surrounding opening regions in the web, and configured to rotate at a fixed speed when the leg-surrounding opening regions of a single size are formed; an anvil roller facing the cutter roller across the web; and a controller unit configured to control at least a circumferential speed of the cutter roller, wherein the controller unit is configured to control the circumferential speed of the cutter roller in such a manner as to equalize the circumferential speed to a conveyance speed of the web when the first leg-surrounding opening regions are formed, and to make the circumferential speed higher than the conveyance speed of the web when the second leg-surrounding opening regions are formed.

### BRIEF DESCRIPTION OF DRAWINGS

FIG. 1 is a partially cutaway, perspective view of an absorbent article according to one or more embodiments.

FIG. 2 is a diagram for explaining a relevant part of a method of manufacturing an absorbent article according to one or more embodiments.

FIG. 3 is a perspective view of a leg-surrounding opening forming apparatus according to one or more embodiments.

FIG. 4 is a side view (as viewed in the direction of arrow A in FIG. 3) of the leg-surrounding opening forming apparatus of FIG. 3.

FIG. 5 is a developed view of a cutter roller according to one or more embodiments.

FIG. 6 is a block diagram of the leg-surrounding opening forming apparatus according to one or more embodiments.

FIGS. 7(A) and 7(B) are plan views (as viewed in the direction of arrow B in FIG. 3) of the leg-surrounding openings formed by the leg-surrounding opening forming apparatus according to one or more embodiments.

### DETAILED DESCRIPTION

Hereinafter, a method of manufacturing an absorbent article and an apparatus for manufacturing an absorbent article, according to one or more embodiments of the present invention, will be described with reference to the drawings.

Note that, in the following description of the drawings, same or similar reference signs denote same or similar elements and portions. In addition, it should be noted that the drawings are schematic and are not to scale unless otherwise specified. Therefore, specific dimensions and the like should be determined in consideration of the following description. Moreover, the drawings do not necessarily reflect the real-life different dimensional relationships and ratios of components.

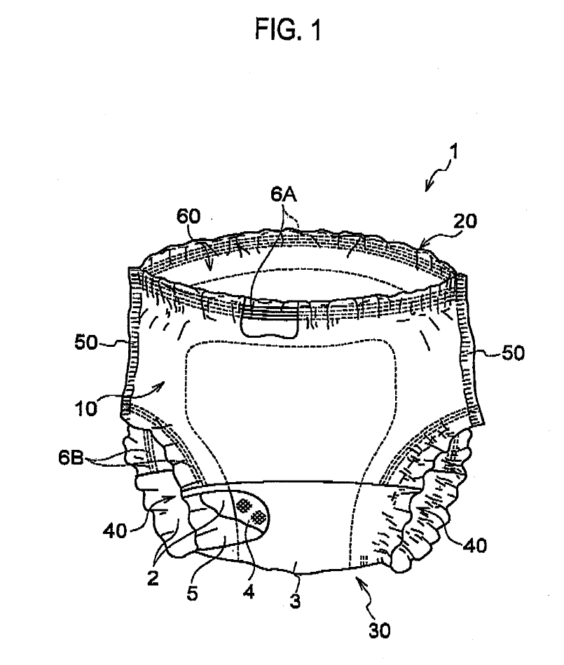

First, a structure of an absorbent article 1 according to one or more embodiments will be described with reference to FIG. 1 which is a partially cutaway perspective view showing the absorbent article 1. In the particularly illustrated embodiment, the absorbent article 1 is a pants-type disposal diaper for adults. The absorbent article 1 may have different sizes, such as L size (first size) and M size (second size).

As shown in FIG. 1, the absorbent article 1 is formed mainly of a top sheet 2, a back sheet 3, an absorber 4, and a waterproof sheet 5.

The top sheet 2 is configured to come into contact with a skin of a person wearing the absorbent article 1 (hereinafter, referred to as “wearer”). As the top sheet 2, a liquid-permeable sheet, such as a non-woven fabric or a perforated plastic film, is used.

The back sheet 3 is provided outside the top sheet 2, in other words, the back sheet is provided at the side farther from the wearer than top sheet 2. As the back sheet 3, a non-woven fabric or the like is used.

The absorber 4 is provided between the top sheet 2 and the back sheet 3, and is configured to absorb excretion of the wearer. As the absorber 4, a mixture of comminuted wood pulp and superabsorbent polymer particles, or the like, is used.

The waterproof sheet 5 is provided between the back sheet 3 and the absorber 4, and does not allow excretion of the wearer to permeate therethrough.

The absorbent article 1 is provided with the top sheet 2, the absorber 4, the waterproof sheet 5 and the back sheet 3 in order, from the skin side of the wearer.

The absorbent article 1 as described above is formed by combining: a front waistline portion 10 to be fitted to the front waist of the wearer; a back waistline portion 20 to be fitted to the back waist of the wearer; and the crotch portion 30 to be fitted to the crotch of the wearer.

Note that, leg-surrounding openings 40 are formed respectively at sides of the crotch portion 20, and the legs of the wearer are to be inserted through the leg-surrounding openings 40.

The front waistline portion 10 and the back waistline portion 20 are united by joint portions 50, and thus form a waistline opening 60 to be fit around the body of the wearer.

A waist gather 6A made of rubber strands or the like having stretchability is provided in the peripheral edges of the front waistline portion 10 and the back waistline portion 20.

For example, the front waistline portion 10 and the back waistline portion 20 may be provided with the waist gather 6A to be thus stretchable in a cross direction crossing a front-to-back direction extending from the front waistline portion 10 to the back waistline portion 20, or may themselves be formed of sheets having stretchability to be thus stretchable in the cross direction.

The crotch portion 30 is provided between the front waistline portion 10 and the back waistline portion 20.

Leg gathers 6B each made of rubber strands or the like having stretchability are provided respectively at the sides of the crotch portion 30.

For example, the crotch portion 30 may be provided with the leg gathers 6B to be thus stretchable in the front-to-back direction of the absorbent article 1, or may itself be formed of a sheet having stretchability to be thus stretchable in the front-to-back direction of the absorbent article 1.

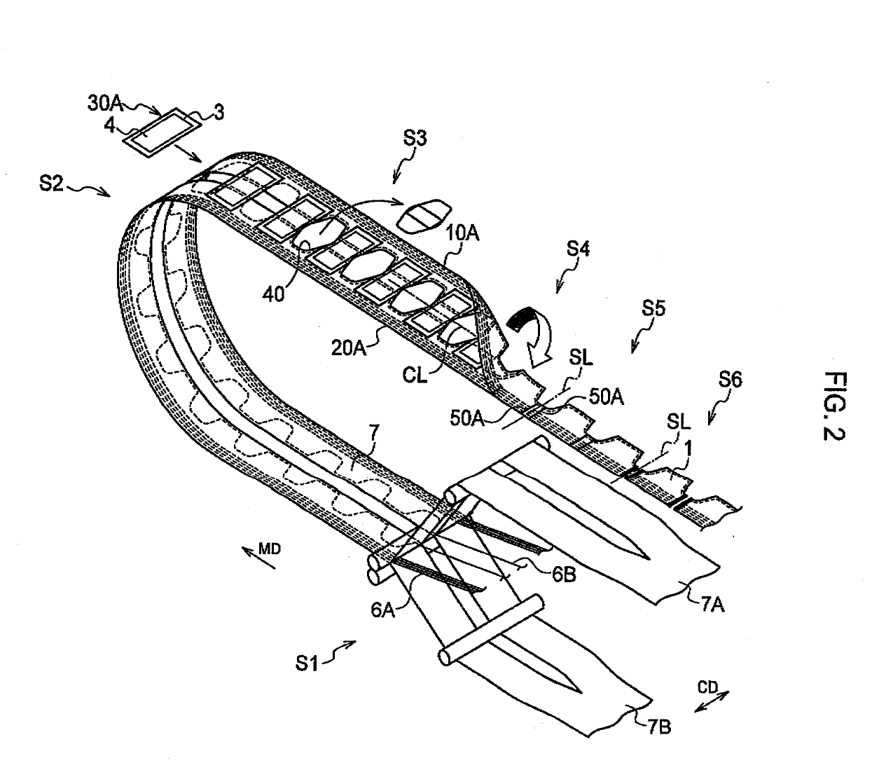

Next, a method of manufacturing an absorbent article 1 according to one or more embodiments will be described with reference to FIG. 2 which is an explanatory view for explaining a relevant part of the absorbent article manufacturing method.

As shown in FIG. 2, the method of manufacturing the absorbent article 1 includes at least a waistline forming step S1, an absorber transferring step S2, a leg-surrounding opening forming step S3, a folding step S4, a joining step S5, and a cutting step S6.

In the waistline forming step S1, a web 7 is formed by disposing gathers (the waist gather 6A and/or the leg gathers 6B) between a web 7A and a web 7B. The web 7 is to be processed into the front waistline portion 10 and the back waistline portion 20.

Note that, the web 7 (the webs 7A and 7B) being conveyed is stretchable in a cross direction CD (a width direction) orthogonal to a conveyance direction MD (Machine Direction) of the web 7.

In addition, the web 7 is asymmetrical with respect to a center line CL that bisects a width in the cross direction CD of the web 7 and extends in the conveyance direction MD of the web 7.

In the absorber transferring step S2, a crotch portion member 30A to be processed into the crotch portion 30 is transferred onto the web 7, specifically, between the front waistline portion 10 and the back waistline portion 20, after the waistline forming step S1. Note that, the crotch portion member 30A is formed of the back sheet 3 and the absorber 4.

In the leg-surrounding opening forming step S3, after the absorber transferring step S2, a leg-surrounding Opening forming apparatus 100 to be described later cuts the web 7 (webs 7A, 7B) together with the back sheet 3 constituting the crotch portion member 30A, and thereby forming the leg-surrounding openings 40.

Here, the formation of the leg-surrounding opening 40 does not necessarily involve cutting the web 7 (webs 7A, 7B) and the back sheet 3, but may involve cutting only the webs 7A, 7B.

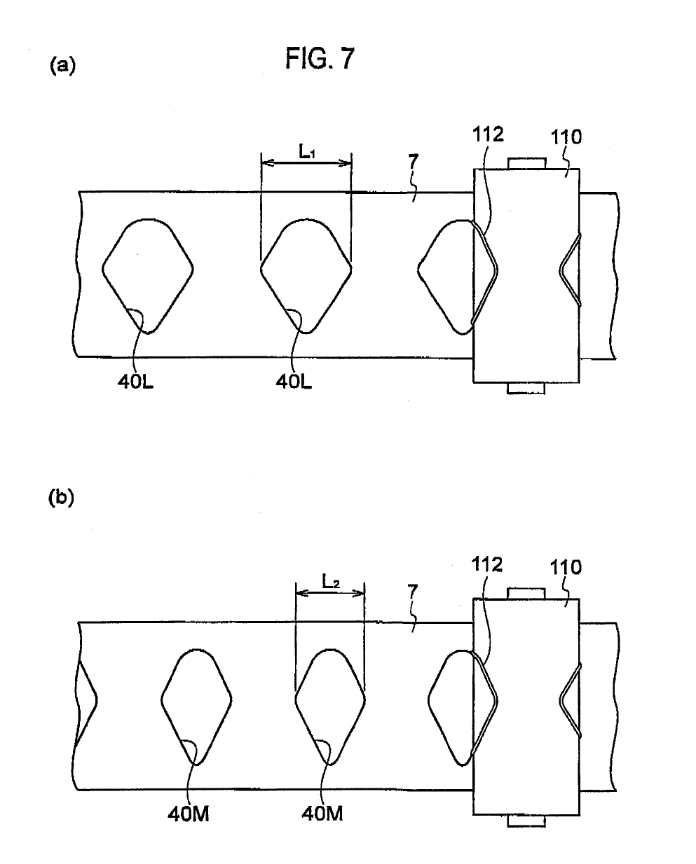

Specifically, in the leg-surrounding opening forming step S3, L-size openings 40L (first leg-surrounding openings, FIG. 7(A)) for the absorbent article 1 of L size (first size) or M-size openings 40M (second leg-surrounding openings, FIG. 7(B)) for the absorbent article 1 of M size (second size) are formed in the web 7.

Here, the size L₁ (FIG. 7(A)) of the L-size opening 40L in the conveyance direction MD of the web 7 is larger than the size L₂ (FIG. 7(B)) of the M-size opening 40M in the conveyance direction MD of the web 7.

Here, the absorber transferring step S2 and the leg-surrounding opening forming step S3 may be performed in the reverse order.

In the folding step S4, the web 7 is folded in half along a folding line extending in the conveyance direction MD of the web 7, by bringing a side edge 10A of the front waistline portion 10 in the web 7 toward a side edge 20A of the back waistline portion 20 in the web 7, after the leg-surrounding opening forming step S3.

Note that, in the particularly illustrated embodiment, the folding line is the same as the center line CL. Moreover, the folding line does not necessarily coincide with the center line CL, and may be offset from the center line CL toward the side edge 10A or toward the side edge 20A.

In the joining step S5, the folded parts of the web 7 are joined at joint regions 50A to be processed into the joint portions 50 of the absorbent article 1 by an ultrasonic treatment or a heat treatment, after the folding step S4.

Note that the joint regions 50A respectively indicate regions at both sides of an imaginary line SL in the conveyance direction MD. The imaginary line SL indicates a cutting line extending in the width direction CD.

In the cutting step S6, the web 7 in which the joint regions 50A have been joined is cut along the imaginary line SL after the joining step S5. As a result, the absorbent article 1 is manufactured.

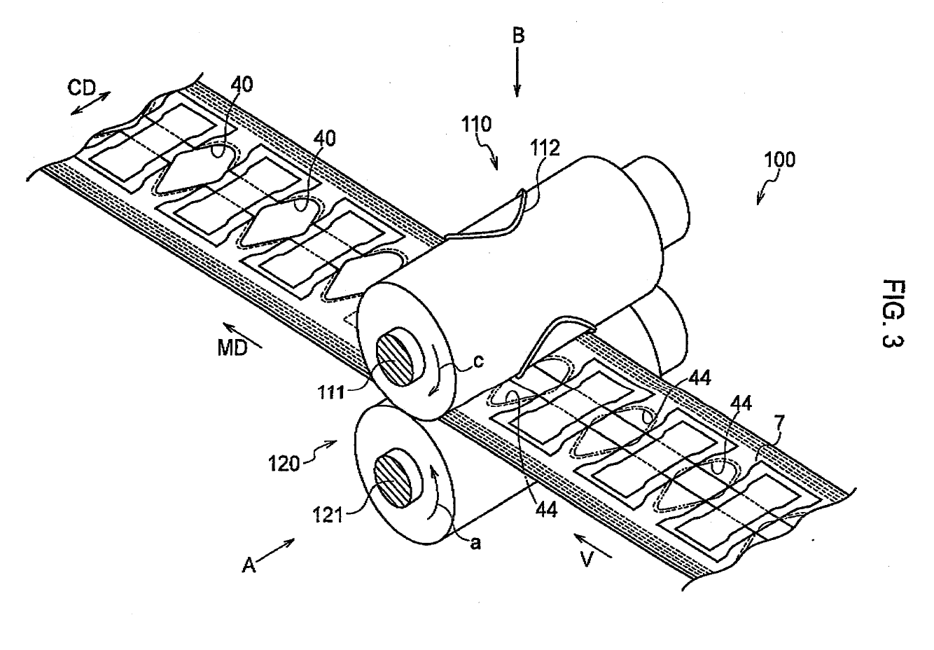

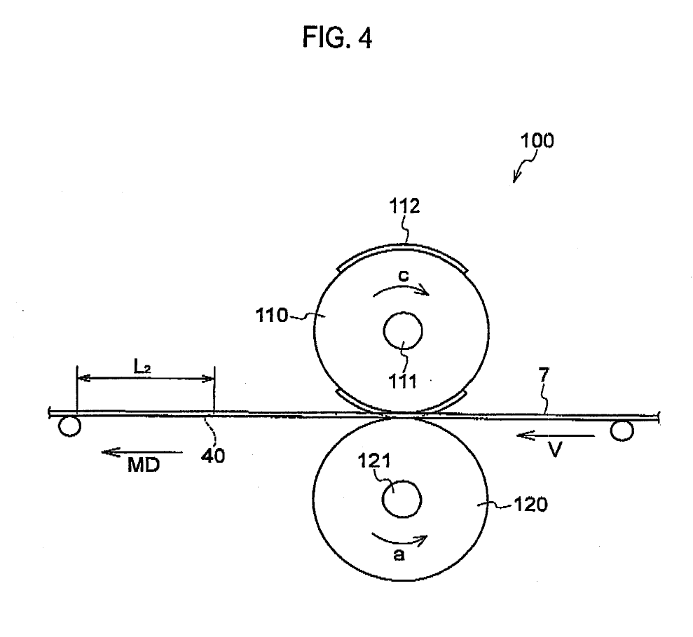

Hereinafter, a configuration of the leg-surrounding opening forming apparatus 100 used, e.g., in the foregoing leg-surrounding opening forming step S3 will be described with reference to FIGS. 3-7.

As shown in FIGS. 3 to 7, the leg-surrounding opening forming apparatus 100 is configured to form the L size openings 40L and the M size openings 40M in the web 7. The leg-surrounding opening forming apparatus 100 includes the cutter roller 110, an anvil roller 120 and a controller unit 130.

The cutter roller 110 is provided on an upper side of the web being conveyed. In the embodiment shown in FIG. 3, the cutter roller 110 is provided on a web 7B side. The web 7B side is a side where the absorber 4 is disposed. The cutter roller 110 is rotated about a shaft 111 by a drive mechanism 110A such as a gear and a motor which are configured to rotate the cutter roller 110.

The Outer periphery of the cutter roller 110 is provided with at least one (two in the particularly illustrated embodiment) blades 112 configured to cut predetermined regions 44 in the web 7 that correspond to the L size openings 40L.

Each of the blades 112 may have a curved shape on the outer circumferential surface of the cutter roller 110, the arc shape corresponding to the L size opening 40L.

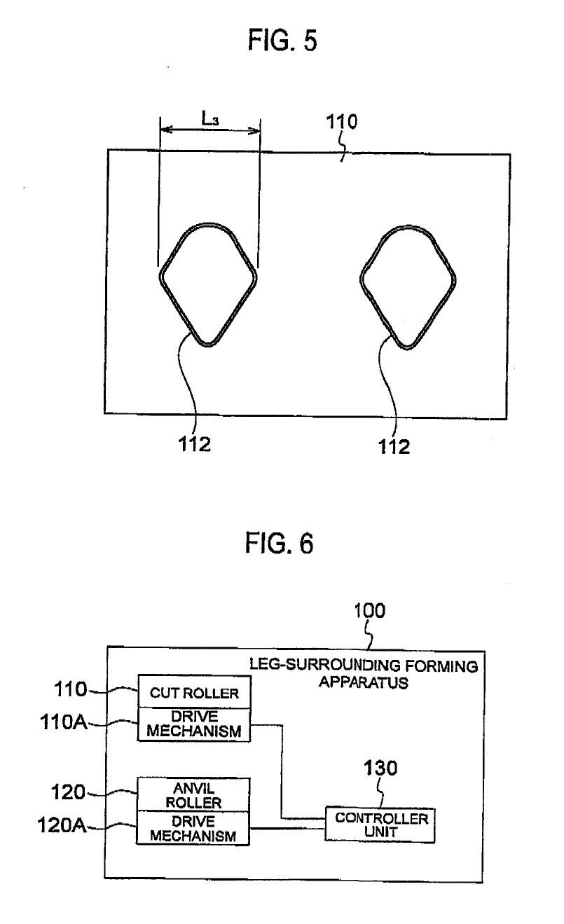

The size L₃ of the blade 112 in the conveyance direction MD of the web 7 is equal to the size L₁ of the L size opening 40L in the conveyance direction MD of the web 7 (see FIGS. 5 and 7).

The cutter roller 110 rotates in a fixed speed to form the leg-surrounding openings of the same size (namely, the L size openings 40L or the M size openings 40M).

The anvil roller 120 is provided at a position facing the cutter roller 110 across the web 7 being conveyed (namely, on a lower side of the web 7).

The anvil roller 120 is rotated about a shaft 121 by a drive mechanism 120A such as a gear and a motor configured to rotate the anvil roller 120.

The controller unit 130 is connected to the cutter roller 110 through the drive mechanism 110A, and is connected to the anvil roller 120 through the drive mechanism 120A.

The controller unit 130 is configured to control the circumferential speed of the cutter roller 110 (hereinafter, referred to as a cutter circumferential speed c) and the circumferential speed of the anvil roller 120 (hereinafter, referred to as an anvil circumferential speed a).

Next, a control method performed by the foregoing controller unit 130 will be described with reference to Table 1 and FIG. 7.

Table 1 shows a relationship between the cutter circumferential speed c and other speeds, i.e., the anvil circumferential speed a and the web conveyance speed v.

FIGS. 7(A) and 7(B) are plan views (views along arrow B in FIG. 3) of the leg-surrounding openings 40 formed by the leg-surrounding opening forming apparatus 100 according to one or more embodiments.

TABLE 1

| | | CUTTER | ANVIL | WEB |
|---|---|---|---|---|
| | | CIRCUM- | CIRCUM- | CONVEY- |
| | | FERENTIAL | FERENTIAL | ANCE |
| | | SPEED c | SPEED a | SPEED v |
| L SIZE | L SIZE | MEDIUM | MEDIUM | MEDIUM |
| STANDARD | M SIZE | HIGH | MEDIUM | MEDIUM |

* STANDARD SPEED IS MEDIUM SPEED

As shown in Table 1, the controller unit 130 is configured to perform such control as to equalize the anvil circumferential speed a to the cutter circumferential speed c (a=c).

Here, the rotational speeds a and c having a ±5% difference from each other are regarded as “equal”.

Note that the conveyance speed v of the web 7 to form the L size openings 40L is equal to that to form the M size openings 40M. At the given conveyance speed v of the web 7, the blades 112 are selected to cut the predetermined regions 44 in the web 7 corresponding to the L size openings 40L.

Thus, the size L₃ of each of the blades 112 in the conveyance direction MD of the web 7 is equal to the size L₁ of the L size opening 40L in the conveyance direction MD of the web 7 (see FIGS. 5 and 7).

Therefore, in this particularly illustrated embodiment, the standard opening size is the L size. Table 1 indicates this by the notation “L Size Standard.”

As used herein, the standard opening size is the size of an opening cut by the blade 112 when the cutter circumferential speed c is equal to the conveyance speed v of the web 7 (c=v). Here, the cutter circumferential speed c within a difference of ±5% of the conveyance speed v of the web 7 is regarded as “equal” to the conveyance speed v.

When the L size openings 40L are formed, the controller unit 130 is configured to perform such control as to equalize the cutter circumferential speed c to the conveyance speed v of the web 7 (c=v).

Under this control, the leg-surrounding opening forming apparatus 100 can be configured to form the L size openings 40L as shown in FIG. 7(A).

In contrast, when the M size openings 40M are formed, the controller unit 130 is configured to perform such control as to make the cutter circumferential speed c higher than the conveyance speed v of the web 7 (c>v).

Under this control, the leg-surrounding opening forming apparatus 100 can form the M size openings 40M as shown in FIG. 7(B).

In the aforementioned embodiment, when the L size openings 40L are formed, the cutter circumferential speed c is equal to the conveyance speed v of the web 7 (c=v).

In contrast, when the M size openings 40M are formed, the cutter circumferential speed c is higher than the conveyance speed v of the web 7 (c>v).

At these speeds, the single cutter roller 110 can form the leg-surrounding openings 40 of different sizes. Therefore, the size of the leg-surrounding opening 40 in the conveyance direction MD of the web 7 can be changed without exchanging the cutter roller 110.

In addition, since the cutter circumferential speed c is higher than the conveyance speed v of the web 7 (c>v) when the M size openings 40M are formed, the cutter circumferential speed c never falls below the conveyance speed v of the web 7 while forming the leg-surrounding openings 40 of any of a number of sizes smaller than the standard opening size.

The cutter circumferential speed c thus set allows the predetermined regions 44 in the web 7 to be more easily cut, and also more surely prevents a crease (twist) in the web 7 due to the contact of the web 7 and the blades 112, than in the case where the cutter circumferential speed c is lower than the conveyance speed v of the web 7.

Generally, a linear blade corresponding to the imaginary lines SL are provided to the outer periphery of a cutter roller (not shown) to cut the web 7 along the imaginary lines SL extending in a cross direction CD of the web 7 in the foregoing cutting step S6.

The linear blade extends in the cross direction CD of the web 7, and thus is in contact with the web 7 only briefly when cutting the web 7.

Accordingly, even if the cutter circumferential speed c of the cutter roller carrying such a linear blade is lower than the conveyance speed v of the web 7, the web 7 is completely cut in the cross direction CD of the web 7 in a single cutting action.

In contrast, each of the blades 112 described above has the curved shape, corresponding to the L size opening 40L, on the outer periphery of the cutter roller 110. In other words, the blade 112 includes a portion extending in the conveyance direction MD of the web 7. Thereby, the blade 112 is in contact with the web 7 for a longer time than the linear blade when cutting the web 7.

Furthermore, since the blades 112 cut only the predetermined regions 44 of the web 7 when cutting the web 7, portions of the web 7 to be formed into the front waistline portion 10 and the back waistline portion 20 are left uncut by the blade 112 and are stretched under tension.

For example, if the cutter peripheral speed c is lower than the conveyance speed v, this speed difference may result in occurrence of a crease (twist) in the web 7, because the blades 112 cut only the predetermined regions 44 of the web 7 with the web 7 being stretched at the portions left uncut for forming the front waistline portion 10 and the back waistline portion 20.

With this consideration, this embodiment performs such control as not to make the cutter circumferential speed c lower than the conveyance speed v of the web 7. Thereby, the leg-surrounding openings 40 of various sizes can be formed while a crease is surely prevented from occurring in the web 7.

Additionally, the cutter roller 110 rotates at a fixed speed to form the leg-surrounding openings 40 of a single size. In this case, the cutter circumferential speed c does not change during one rotation of the cutter roller 110.

To put it differently, even when the cutter roller 110 is heavy, the rotation at the fixed cutter circumferential speed c is less likely to impose a load on the drive mechanism 110A than in the case where the cutter circumferential speed c changes during one rotation of the cutter roller 110.

Therefore, failure in the leg-surrounding opening forming apparatus 100 at the drive mechanism 110A or any other portion can be reduced.

Moreover, since the cutter roller 110 is capable of forming the leg-surrounding openings 40 at a fixed speed, a crease (twist) in the web 7 due to contact of the web 7 and the blade 112 can be prevented and thus the leg-surrounding openings 40 can be formed in stable shapes, unlike the case where the cutter circumferential speed c changes during one rotation of the cutter roller 110. Thereby, manufacturing defects in the manufactured absorbent articles can be prevented or at least reduced.

In this embodiment, the anvil circumferential speed a is equal to the cutter circumferential speed c. Thereby, there is no speed difference between the rollers on the cutter roller 110 side surface of the web 7 and on the anvil roller 120 side surface of the web 7.

Therefore, a crease in the we due to the contacts of the web 7 and the blade 112/anvil roller 120 is prevented, and thus the leg-surrounding openings 40 can be formed in stable shapes.

In this embodiment, the conveyance speed v of the web to form the L size openings 40L is equal to the conveyance speed v of the web 7 to form the M size openings 40M.

In other words, the absorbent article 1 can be manufactured without changing the speed of the manufacturing line, because the conveyance speed v of the web 7 does not change even if the size of the absorbent article 1 is changed.

### Modified Example

The leg-surrounding opening forming apparatus 100 according to the foregoing description may be modified as follows.

Table 2 shows the relationship between the cutter circumferential speed c and other velocities, i.e., the anvil circumferential speed a and the web conveyance speed v, according to the Modified Example.

Note that the same elements and portions as in the leg-surrounding opening forming apparatus 100 according to the foregoing description are denoted by the same reference signs, and different elements and portions will be mainly described.

In the foregoing description, the leg-surrounding opening forming apparatus 100 is configured to form the leg-surrounding openings 40 of two different sizes (L size and M size). In contrast, in the Modified Example, the leg-surrounding opening forming apparatus 100 is configured to form the leg-surrounding openings 40 of three different sizes (L size, M size, and S size). More than three sizes are also within the scope of this disclosure.

TABLE 2

| | | CUTTER ROLLER | ANVIL ROLLER | WEB |
|---|---|---|---|---|
| | | CIRCUM- | CIRCUM- | CONVEY- |
| | | FERENTIAL | FERENTIAL | ANCE |
| | | SPEED c | SPEED a | SPEED v |
| L | L SIZE | MEDIUM | MEDIUM | MEDIUM |
| SIZE | M SIZE | HIGH | MEDIUM | MEDIUM |
| BASIS | S SIZE | SUPER HIGH | MEDIUM | MEDIUM |

* STANDARD SPEED IS MEDIUM SPEED

As shown in Table 2, the standard opening size is the L size. Taking the speeds to form the L size openings 40L as standards, for example, the controller unit 130 is configured to perform such control as to make the cutter circumferential speed c to form the leg-surrounding openings 40 for S size (S size openings) higher than the cutter circumferential speed c to form the M size openings 40M.

Here, it should be noted that HIGH is 1-5% higher than MEDIUM, and SUPER HIGH is 6-10 higher than MEDIUM.

### Further Embodiments

As described above, the details of several embodiments of the present invention have been disclosed. It should not be understood that the description and drawings which constitute part of this disclosure limit the present invention. Based on this disclosure, those skilled in the art may easily come up with various alternative embodiments, examples and operation techniques.

For example, the following additional embodiments can be envisaged. Specifically, the leg-surrounding opening forming apparatus 100 has been described as for forming the leg-surrounding openings 40 of a pants-type disposable diaper. However, the leg-surrounding opening forming apparatus 100 is not limited to this use, and may form openings of any type of diaper such as an open-type disposable diaper, for example.

Specifically, the absorbent article 1 has been described as including, in combination, the front waistline portion 10, the back waistline portion 20, and the crotch portion 30. However, the absorbent article 1 is not limited to this structure, and may be formed in a single unit. In this case, a different method of manufacturing such an absorbent article is used.

In addition, the controller unit 130 has been described as for performing such control as to equalize the anvil circumferential speed a to the cutter circumferential speed c. However, the controller unit 130 may not always have to perform the a=c control in the foregoing manner, but may perform such control as to make the anvil circumferential speed a and the cutter circumferential speed c different from each other.

Moreover, it has been described that the same conveyance speed v of the web 7 is used to form the L size openings 40L and to form the M size openings 40M.

However, the conveyance speed v of the web 7 does not have to be the same, but may be changed depending on the sizes. For example, the conveyance speed v of the web 7 may be made higher to form the L size openings 40L than to form the M size openings 40M.

As described above, the present invention naturally includes various embodiments which are not described herein. Accordingly, the technical scope of the present invention should be determined only by the matters to define the invention in the scope of claims regarded as appropriate based on the description.

The entire content of Japanese Patent Applications 2009-048416 (filed on Mar. 2, 2009) and 2010-041926 (filed on Feb. 26, 2010) are incorporated herein by reference.

### INDUSTRIAL APPLICABILITY

Therefore, according to the present invention, it is possible to provide a leg-surrounding opening forming apparatus and a method of manufacturing an absorbent article that are capable of reducing apparatus breakdown and more surely preventing manufacturing defects of absorbent articles when manufacturing leg-surrounding openings of different sizes.

### REFERENCE SIGNS LIST

1 absorbent article
2 top surface sheet
3 bottom surface sheet
4 absorber
5 waterproof sheet
6 gather
6A waist gather
6B leg gather
7, 7A, 7B web
10 front waistline portion
10A first side edge portion
20 back waistline portion
20A second side edge portion
30 crotch portion
30A crotch portion member
40 leg-surrounding openings
40L L size opening regions
40M M size opening regions
44 predetermined region
50 joint portions
50A joint regions
60 body-surrounding openings
100, 100A leg-surrounding forming apparatus
110 cutter roller
111 shaft core
112 blade
120 anvil roller
120A drive mechanism
121 shaft core
130 controller

1. A leg-surrounding forming apparatus configured to form first leg-surrounding opening regions for a first size of an absorbent article and second leg-surrounding opening regions for a second size of the absorbent article in a continuous web to be processed into absorbent articles each having at least leg-surrounding opening regions formed therein, the apparatus comprising:
a cutter roller having an outer circumferential surface provided with blades to cut predetermined regions corresponding to the first leg-surrounding opening regions in the web, and configured to rotate at a fixed speed when the leg-surrounding opening regions of a single size are formed;
an anvil roller facing the cutter roller across the web; and
a controller unit configured to control at least a circumferential speed of the cutter roller, wherein
the controller unit is configured to control the circumferential speed of the cutter roller in such a manner as to equalize the circumferential speed of the cutter roller to a conveyance speed of the web when the first leg-surrounding opening regions are formed, and to make the circumferential speed for the cutter roller higher than the conveyance speed of the web when the second leg-surrounding opening regions are formed.

2. The leg-surrounding forming apparatus according to claim 1, wherein
a circumferential speed of the anvil roller is equal to the circumferential speed of the cutter roller.

3. The leg-surrounding forming apparatus according claim 1, wherein
the conveyance speed of the web is the same for formation of the first leg-surrounding opening regions and for formation of the second leg-surrounding opening regions.

4. A method of manufacturing an absorbent article having at least leg-surrounding opening regions formed therein, the method comprising
the step of a leg-surrounding forming apparatus forming either first leg-surrounding opening regions for a first size of the absorbent article or second leg-surrounding opening regions for a second size of the absorbent article, in a continuous web to be processed into absorbent articles, wherein
the leg-surrounding forming apparatus comprises:
a cutter roller having an outer circumferential surface provided with blades to cut predetermined regions corresponding to the first leg-surrounding opening regions in the web, and configured to rotate at a fixed speed when the leg-surrounding opening regions of a single size are formed;
an anvil roller facing the cutter roller across the web; and
a controller unit configured to control at least a circumferential speed of the cutter roller, and
the controller unit controls the circumferential speed of the cutter roller in such a manner as to equalize the circumferential speed of the cutter roller to a conveyance speed of the web when the first leg-surrounding opening regions are formed and to make the circumferential speed of the cutter roller higher than the conveyance speed of the web when the second leg-surrounding opening regions are formed.
